(19) United States
(12) Patent Application Publication
(10) Pub. No.: US 2024/0373482 A1
(43) Pub. Date: Nov. 7, 2024

(54) TDLS PEER STA AWARENESS OF TWT SCHEDULE

(71) Applicant: Samsung Electronics Co., Ltd., Suwon-si (KR)

(72) Inventors: Rubayet Shafin, Allen, TX (US); Elliot Jen, Taipei City (TW); Yue Qi, Plano, TX (US); Boon Loong Ng, Plano, TX (US); Peshal Nayak, Plano, TX (US); Vishnu Vardhan Ratnam, Plano, TX (US)

(21) Appl. No.: 18/641,192

(22) Filed: Apr. 19, 2024

Related U.S. Application Data
(60) Provisional application No. 63/464,418, filed on May 5, 2023.
(60) Provisional application No. 63/538,247, filed on Sep. 13, 2023.
(60) Provisional application No. 63/538,414, filed on Sep. 14, 2023.

(51) Int. Cl. H04W 76/10; H04W 84/12

(52) U.S. Cl. CPC H04W 76/10; H04W 84/12

(57) ABSTRACT

Methods and apparatuses for TDLS peer STA awareness of a TWT schedule. A method of wireless communication performed by a first STA, the method comprising: establishing a TDLS direct link with a second STA, wherein the first STA and the second STA are associated with an AP; obtaining membership of an R-TWT schedule or a B-TWT schedule that allows P2P communication between the first STA and the second STA during a corresponding R-TWT SP or B-TWT SP; determining an intention to transmit frames to the second STA during the R-TWT SP or the B-TWT SP corresponding to the R-TWT schedule or the B-TWT schedule; and transmitting a TDLS TWT notification frame to the second STA prior to a start of the R-TWT SP or the B-TWT SP, wherein the TDLS TWT notification frame includes information associated with a schedule of the R-TWT or the B-TWT.

### CROSS-REFERENCE TO RELATED APPLICATION AND CLAIM OF PRIORITY

This application claims priority under 35 U.S.C. § 119(e) to U.S. Provisional Patent Application No. 63/464,418 filed on May 5, 2023, U.S. Provisional Patent Application No. 63/538,247 filed on Sep. 13, 2023, and U.S. Provisional Patent Application No. 63/538,414 filed on Sep. 14, 2023, which are hereby incorporated by reference in their entirety.

### TECHNICAL FIELD

This disclosure relates generally to target wake time (TWT) in wireless communications systems, and more particularly to tunneled direct link setup (TDLS) peer station (STA) awareness of a TWT schedule.

### BACKGROUND

Wireless local area network (WLAN) technology allows devices to access the internet in the 2.4 GHZ, 5 GHZ, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Multi-link operation (MLO) is a feature that is currently being developed by the standards body for next generation extremely high throughput (EHT) wireless fidelity (Wi-Fi) systems in IEEE 802.11be. The Wi-Fi devices that support MLO are referred to as multi-link devices (MLD). With MLO, it is possible for a non-access point (AP) multi-link device (MLD) to discover, authenticate, associate, and set up multiple links with an AP MLD. Channel access and frame exchange is possible on each link between the AP MLD and non-AP MLD.

### SUMMARY

Embodiments of the present disclosure provide methods and apparatuses for TDLS peer STA awareness of a TWT schedule.

In one embodiment, a method of wireless communication performed by a first STA is provided, the method comprising: establishing a TDLS direct link with a second STA, wherein the first STA and the second STA are associated with an access point (AP) device; obtaining membership of a restricted target wake time (R-TWT) schedule or a broadcast TWT (B-TWT) schedule that allows peer-to-peer (P2P) communication between the first STA and the second STA during a corresponding R-TWT service period (SP) or B-TWT SP; determining an intention to transmit frames to the second STA during the R-TWT SP or the B-TWT SP corresponding to the R-TWT schedule or the B-TWT schedule; and transmitting a TDLS TWT notification frame to the second STA prior to a start of the R-TWT SP or the B-TWT SP, wherein the TDLS TWT notification frame includes information associated with a schedule of the R-TWT or the B-TWT.

In another embodiment, a first STA device is provided, comprising a transceiver and a processor operably coupled to the transceiver. The processor configured to: establish a TDLS direct link with a second STA, wherein the first STA and the second STA are associated with an AP device; obtain membership of an R-TWT schedule or a B-TWT schedule that allows P2P communication between the first STA and the second STA during a corresponding R-TWT SP or B-TWT SP; determine an intention to transmit frames to the second STA during the R-TWT SP or the B-TWT SP corresponding to the R-TWT schedule or the B-TWT schedule; and transmit, via the transceiver, a TDLS TWT notification frame to the second STA prior to a start of the R-TWT SP or the B-TWT SP, wherein the TDLS TWT notification frame includes information associated with a schedule of the R-TWT or the B-TWT.

In another embodiment, an AP device is provided, comprising: a transceiver, and a processor operably coupled to the transceiver. The processor is configured to: determine that a first STA associated with the AP device has established a TDLS direct link with a second STA associated with the AP device; determine that the first STA is a member of an R-TWT schedule that allows P2P communication between the first STA and the second STA during a corresponding R-TWT SP; determine an intention of the first STA to transmit frames to the second STA during the R-TWT SP corresponding to the R-TWT schedule; and transmit, via the transceiver, a TDLS TWT notification frame to the second STA prior to a start of the R-TWT SP, wherein the TDLS TWT notification frame includes information associated with a schedule of the R-TWT.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example of sending a first TDLS discovery request frame for discovering a TDLS peer STA on link 2 according to embodiments of the present disclosure;

FIG. 4 illustrates an example of sending a first TDLS discovery request frame for discovering a TDLS peer STA on link 1 according to embodiments of the present disclosure;

FIG. 5 illustrates an example topology for TDLS communication according to embodiments of the present disclosure;

FIG. 6 illustrates an example of an issue of unavailability of a STA during a restrictive TWT (R-TWT) service period (SP) of a TDLS peer according to embodiments of the present disclosure;

FIG. 7 illustrates an example of the usage of the TDLS TWT notification frame according to embodiments of the present disclosure;

FIG. 8 illustrates an example of the usage of the TDLS TWT awareness frame according to embodiments of the present disclosure;

FIG. 9A illustrates an example method for the usage of the TDLS TWT notification frame by a STA that is a member of the R-TWT schedule according to embodiments of the present disclosure;

FIG. 9B illustrates an example method for the behavior of a TDLS peer STA that receives a TDLS TWT notification frame from its peer STA according to embodiments of the present disclosure;

FIG. 10 illustrates an example format for the TDLS TWT notification frame according to embodiments of the present disclosure;

FIG. 11 illustrates an example format for the TDLS information field in the TDLS TWT notification frame according to embodiments of the present disclosure;

FIG. 12 illustrates another example format for the TDLS information field in the TDLS TWT notification frame according to embodiments of the present disclosure;

FIG. 13 illustrates an example format for the TDLS TWT awareness frame according to embodiments of the present disclosure;

FIG. 14 illustrates an example format for the TWT information field of the TDLS TWT awareness frame according to embodiments of the present disclosure;

FIG. 15 illustrates an example format for the TDLS TWT notification element according to embodiments of the present disclosure;

FIG. 16 illustrates an example format for the TWT information field in the TDLS TWT notification element according to embodiments of the present disclosure;

FIG. 17 illustrates an example of TDLS TWT notification expiration according to embodiments of the present disclosure;

FIG. 18 illustrates an example of the termination of the TDLS TWT awareness requirement according to embodiments of the present disclosure;

FIG. 19 illustrates an example method for the usage of the TDLS end frame according to embodiments of the present disclosure;

FIG. 20 illustrates an example method for the behavior of a TDLS peer STA upon receiving the TDLS TWT according to embodiments of the present disclosure;

FIG. 21 illustrates an example format for the TDLS TWT notification frame according to embodiments of the present disclosure;

FIG. 22A illustrates an example format for the TWT information field in the TDLS TWT notification frame according to embodiments of the present disclosure;

FIG. 22B illustrates an example format for the TDLS TWT notification frame including the TWT SP count subfield according to embodiments of the present disclosure;

FIG. 23A illustrates an example format for the TWT information field in the TDLS TWT notification element containing the TWT expiration time according to embodiments of the present disclosure;

FIG. 23B illustrates an example format for the TDLS TWT notification frame including the TWT SP count subfield according to embodiments of the present disclosure;

FIG. 24 illustrates an example format for the TWT information extension element according to embodiments of the present disclosure;

FIG. 25 illustrates an example format for the control field according to embodiments of the present disclosure;

FIG. 26 illustrates an example format for the B-TWT information field according to embodiments of the present disclosure;

FIG. 27 illustrates an example format for the EHT medium access control (MAC) capabilities information element according to embodiments of the present disclosure;

FIG. 28 illustrates an example of a non-TDLS peer-to-peer (P2P) topology according to embodiments of the present disclosure; and

FIG. 29 illustrates an example of a method for wireless communication performed by a first STA device according to embodiments of the present disclosure.

### DETAILED DESCRIPTION

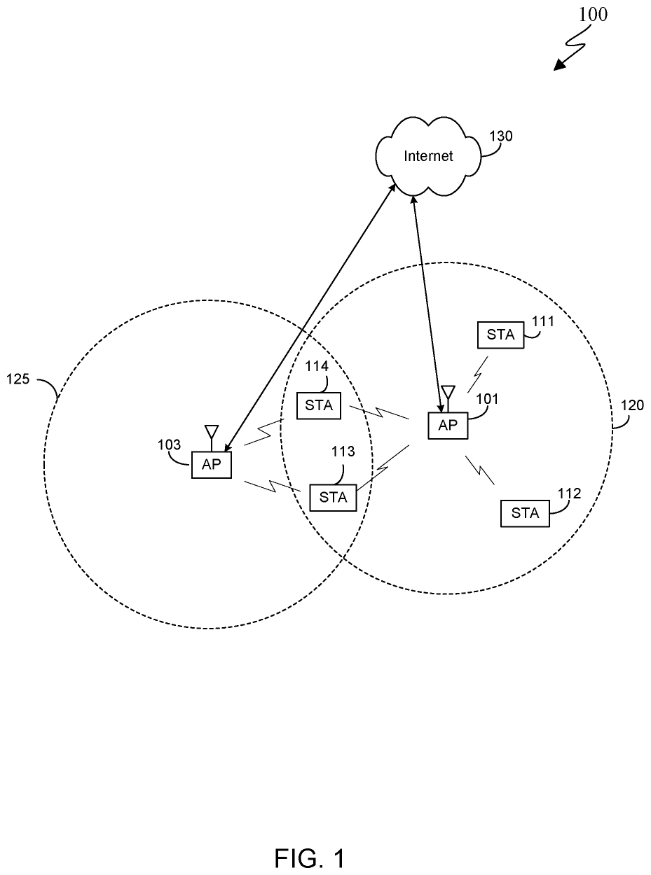

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be—D2.1 “Part 11: Wireless LAN Medium Access Control (MAC) and Physical Layer (PHY) Specifications—Amendment 8: Enhancements for extremely high throughput (EHT)”; [2] IEEE P802.11 REVme Draft D2.1 “Part 11: Wireless LAN Medium Access Control (MAC) and Physical Layer (PHY) Specifications.

Embodiments of the present disclosure provide mechanisms for facilitating TDLS peer STA awareness of a TWT schedule.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating TDLS peer STA awareness of a TWT schedule. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

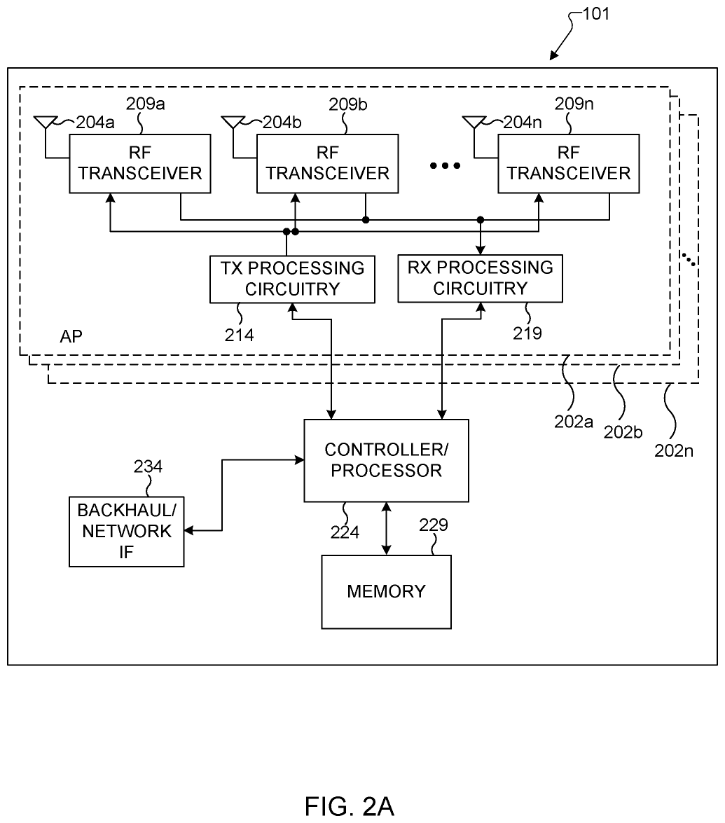

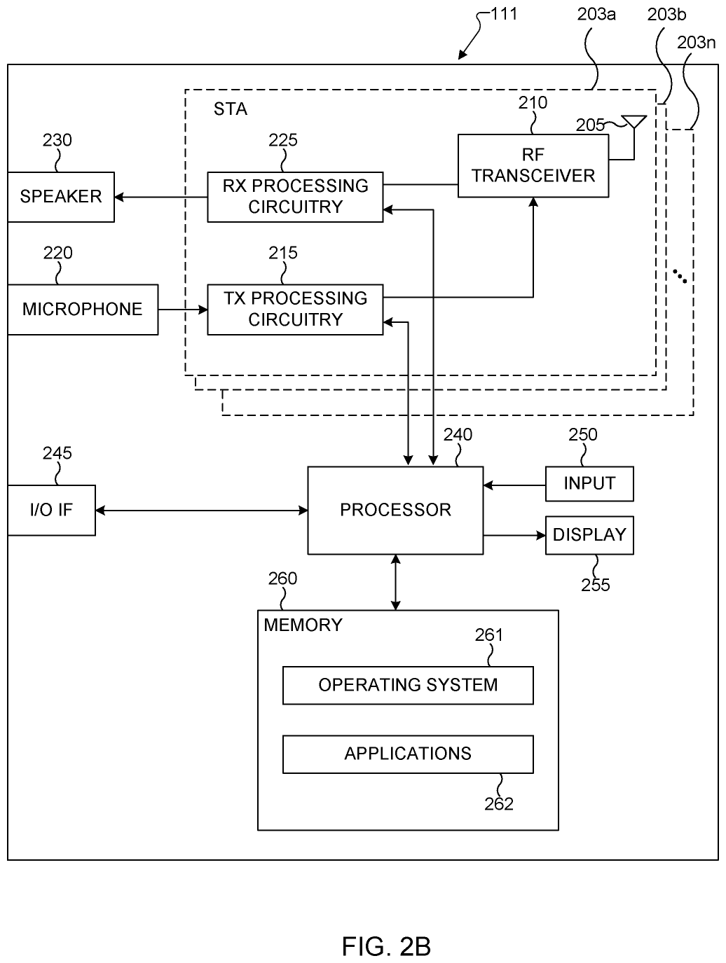

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating TDLS peer STA awareness of a TWT schedule. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating TDLS peer STA awareness of a TWT schedule. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate TDLS peer STA awareness of a TWT schedule. In some embodiments, the controller/processor 240 includes at least one microprocessor or microcontroller.

The controller/processor 240 is also capable of executing other processes and programs resident in the memory 260, such as operations for facilitating TDLS peer STA awareness of a TWT schedule. The controller/processor 240 can move data into or out of the memory 260 as required by an executing process. In some embodiments, the controller/processor 240 is configured to execute a plurality of applications 262, such as applications for facilitating TDLS peer STA awareness of a TWT schedule. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

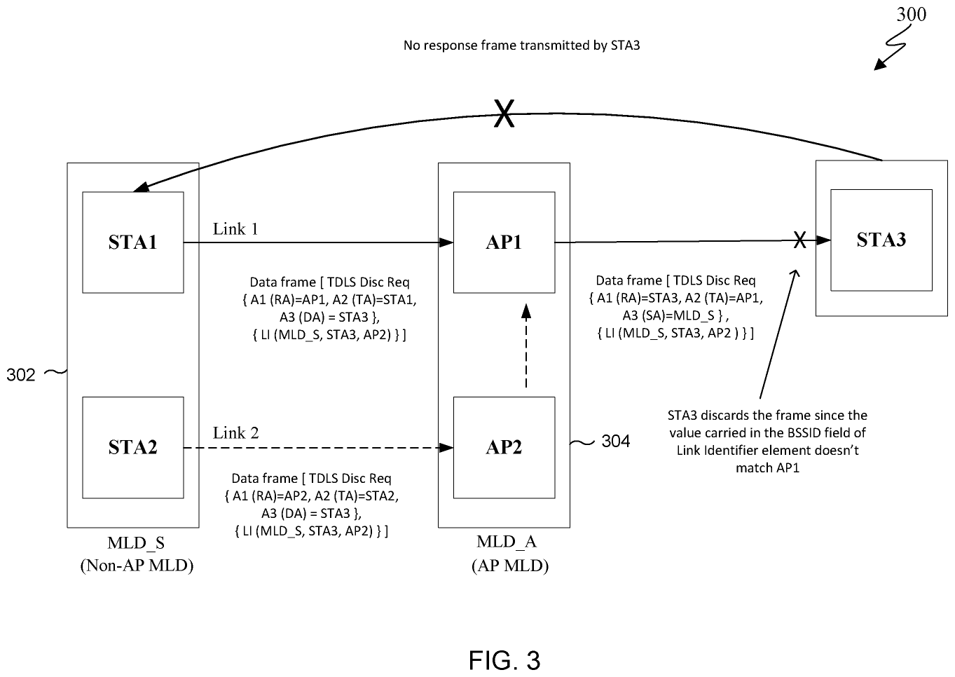

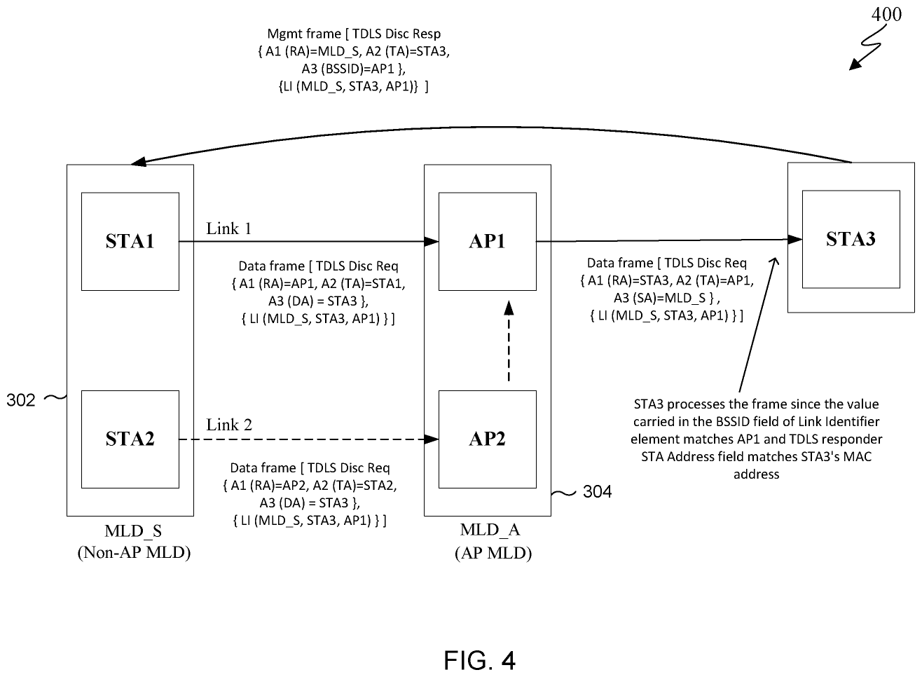

The procedure for discovery and setup of single link TDLS direct link between two non-AP MLDs is defined in the 802.11be specification. The discovery process for discovering a single TDLS peer STA is illustrated in FIG. 3 and FIG. 4.

FIG. 3 illustrates an example 300 of sending a first TDLS discovery request frame for discovering a TDLS peer STA on link 2 according to embodiments of the present disclosure. The embodiment of the example 300 of sending a first TDLS discovery request frame for discovering a TDLS peer STA on link 2 shown in FIG. 3 is for illustration only. Other embodiments of the example of sending a first TDLS discovery request frame for discovering a TDLS peer STA on link 2 could be used without departing from the scope of this disclosure.

FIG. 4 illustrates an example 400 of sending a first TDLS discovery request frame for discovering a TDLS peer STA on link 1 according to embodiments of the present disclosure. The embodiment of the example 400 of sending a first TDLS discovery request frame for discovering a TDLS peer STA on link 1 shown in FIG. 4 is for illustration only. Other embodiments of the example 400 of sending a first TDLS discovery request frame for discovering a TDLS peer STA on link 1 could be used without departing from the scope of this disclosure.

As illustrated in FIGS. 3 and 4, the TDLS discovery is initiated by a non-AP MLD (MLD_S) 302. The MLD_S 302 has performed multi-link setup with an AP MLD (MLD_A) 304. The MLD_S 302 has two affiliated STAs, STA1 and STA2. STA3 is not capable of performing multi-link operation and is not affiliated with a non-AP MLD. The MLD_A 304 has two affiliated APs, AP1 and AP2, where AP1 operates on link 1 and AP2 operates on link 2. STA1 and STA3 operate on link 1 and are associated with AP1. STA2 operates on link 2 and is associated with AP2. In the example, the MLD_S 302 initiates TDLS discovery by transmitting two TDLS Discovery Request frames (which are Data frames) as it does not know which link STA3 is operating on and whether STA3 is an MLD, or a STA not affiliated with an MLD. The first TDLS Discovery Request frame has the BSSID field in the Link Identifier element set to the BSSID of AP1 and the second TDLS Discovery Request frame has this field set to the BSSID of AP2. Both the frames have their A3 (DA) set to the STA3 MAC address and the To DS subfield of the Frame Control field set to 1. The TDLS Discovery Request frame can be transmitted over either link 1 (through STA1 as represented by solid line) or link 2 (through STA2 as represented by dotted line). When the TDLS Discovery Request frame is received at the AP MLD 304 (i.e., through AP1 or AP2), it routes the frame to STA3, through AP1 by setting the From DS subfield of the Frame Control field to 1 and A3 (SA) to the non-AP MLD Address (i.e., MLD_S). STA3 discards the TDLS Discovery Request frame that had the BSSID field of Link Identifier element set to BSSID of AP2 as it does not recognize the BSSID. STA3 recognizes the BSSID set to AP1 and responds with a TDLS Discovery Response frame, which is a Management frame, with the RA set to the MLD_S and both To DS and From DS subfields set to 0. STA3 ignores the TDLS Multi-Link element as it does not recognize this element. The TDLS STA affiliated with the MLD_S 302 receives the TDLS Discovery Response frame, which is sent on the TDLS direct link. The TDLS initiator STA Address field and the TDLS responder STA Address field contained in the Link Identifier element (denoted as LI in the figure) are carried in the TDLS Discovery Request frame and in the TDLS Discovery Response frame and are set to MLD_S and STA3, respectively.

TWT is an important feature for power management in Wi-Fi (wireless fidelity) networks, which was developed by IEEE 802.11ah and later adopted and modified into IEEE 802.11ax. TWT allows an AP to manage activity in the BSS to minimize contention between STAs and reduce the required amount of time that a STA utilizing a power management mode needs to be awake. This is achieved by allocating STAs to operate at nonoverlapping times and/or frequencies and concentrating the frame exchange sequences in predefined service periods. With TWT operation, it suffices for an STA to only wake up at a pre-scheduled time negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT SP is used to exchange frames with other STAs. Frames transmitted during a TWT SP are carried in any physical layer protocol data unit (PPDU) format supported by the pair of STAs that have established the TWT agreement corresponding to that TWT SP, including high-efficiency (HE) multi-user (MU) MU PPDU, HE trigger-based (TB) PPDU, etc.

In IEEE 802.11 standards, two types of TWT operation are possible-individual TWT operation and broadcast TWT operation. Individual TWT agreements can be established between two STAs or between an STA and an AP. The negotiation that takes place for an individual TWT agreement between two STAs is on an individual basis. The AP can have TWT agreements with multiple STAs. Any changes in the TWT agreement between the AP and one STA do not affect the TWT agreement between the AP and the other STA.

IEEE 802.11ax first introduced the broadcast TWT operation. The broadcast TWT operates in a membership-based approach. With broadcast TWT operation, an AP can set up a shared TWT session for a group of STAs. The AP is typically the controller of the broadcast TWT schedule. The non-AP STAs in the BSS can request membership in the schedule or the AP can send an unsolicited response to the STA to make the STA a member of the broadcast TWT schedule the AP maintains in the BSS. The AP can advertise/announce and maintain multiple broadcast TWT schedules in the network. When a change is made to any of the schedules in the network, it affects all the STAs that are members of that particular schedule.

TWT enhancements for multi-link devices have recently been introduced in the IEEE 802.11be specification. For individual TWT agreements between two MLDs, a STA affiliated with an MLD, which is a TWT requesting STA, may indicate the link(s) that are requested for setting up TWT agreement(s) in the Link ID Bitmap subfield, if present, of a TWT element in the TWT request. If only one link is indicated in the Link ID Bitmap subfield of the TWT element, then a single TWT agreement is requested for the STA affiliated with the same MLD, which is operating on the indicated link. The Target Wake Time field of the TWT element shall be in reference to the TSF time of the link indicated by the TWT element. A TWT responding STA affiliated with a peer MLD that receives a TWT request that contains a Link ID Bitmap subfield in a TWT element shall respond with a TWT response that indicates the link(s) in the Link ID Bitmap field of a TWT element. The link(s), if present, in the TWT element carried in the TWT response, shall be the same as the link(s) indicated in the TWT element of the soliciting TWT request.

Restricted TWT (rTWT) operation is another feature introduced in IEEE 802.11be standards with a view to providing better support for latency-sensitive applications. Restricted TWT offers a protected service period for its member STAs by sending Quiet elements to other STAs in the BSS which are not a member of the rTWT schedule, where the Quiet interval corresponding to the Quiet element overlaps with the initial portion of the restricted TWT SP. Hence, it gives more channel access opportunities for the rTWT member scheduled STAs, which helps latency-sensitive traffic flow.

Embodiments of the present disclosure recognize that when a first STA becomes a member of a first R-TWT schedule, if the first STA has formed a TDLS direct link with a second STA, then there can exist a number of issues related to the operation of R-TWT and TDLS for the first STA.

Accordingly, embodiments of the present disclosure provide mechanisms to enable the notification to a first STA by a TDLS peer STA about an impending TWT SP during which the first STA is expected to receive frames from the TDLS peer STA.

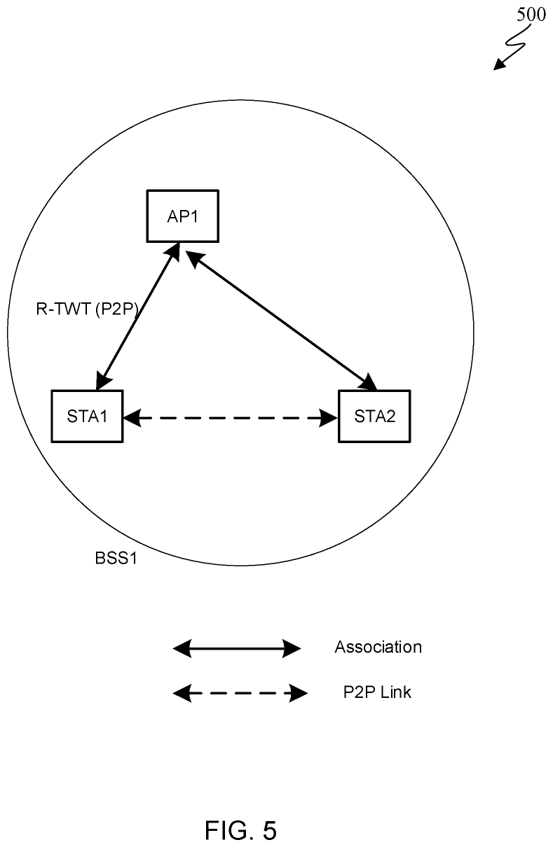

If the first R-TWT schedule allows the first STA the P2P communication during an R-TWT SP corresponding to the first R-TWT schedule, then during the R-TWT SP, the first STA can attempt to transmit a frame to the second STA over the TDLS direct link. However, the second STA can miss the frame due to, for example, the power-saving operation of the second STA (the second STA can be in a doze state when the frame is transmitted by the first STA during the R-TWT SP). This is illustrated in FIG. 5.

FIG. 5 illustrates an example topology for TDLS communication 500 according to embodiments of the present disclosure. The embodiment of the example topology for TDLS communication 500 shown in FIG. 5 is for illustration only. Other embodiments of the example topology for TDLS communication 500 could be used without departing from the scope of this disclosure.

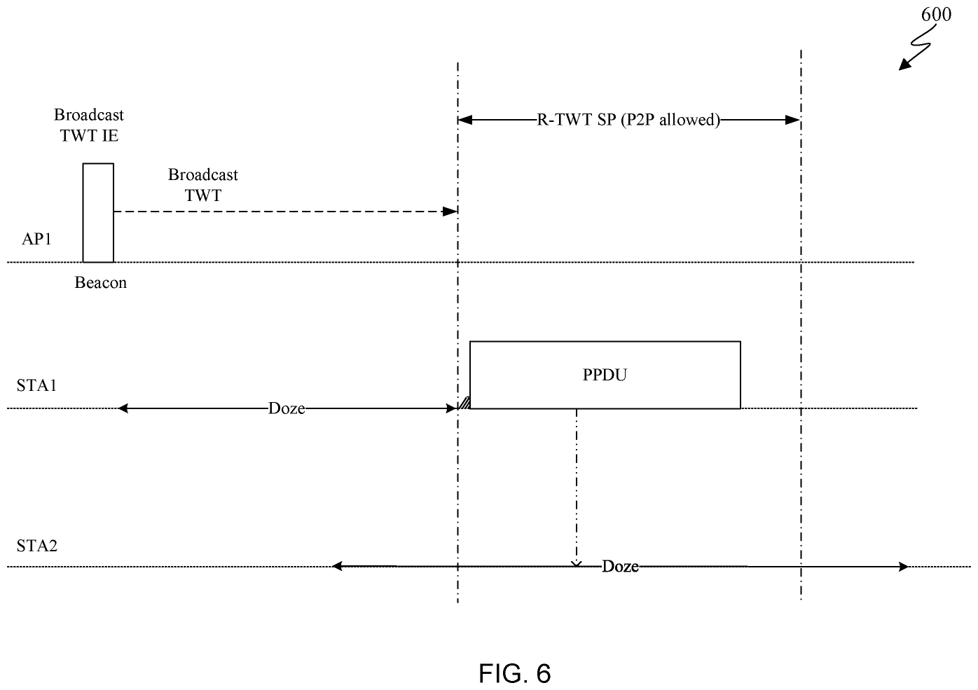

As illustrated in FIG. 5, STA1 and STA2 are associated with AP1. STA1 has formed a TDLS direct link with STA2. STA1 has also become a member of an R-TWT schedule that allows P2P communication during the R-TWT SP. During the R-TWT SP, STA1 may attempt to transmit to STA2. However, at that time, STA2 may not be available. For example, STA2 may be in doze state, and hence, miss the frames transmitted by STA1 during the R-TWT SP. This issue is further illustrated in FIG. 6.

FIG. 6 illustrates an example 600 of an issue of unavailability of a STA during an R-TWT SP of a TDLS peer according to embodiments of the present disclosure. The embodiment of the example 600 of an issue of unavailability of a STA during an R-TWT SP of a TDLS peer shown in FIG. 6 is for illustration only. Other embodiments of the example 600 of an issue of unavailability of a STA during an R-TWT SP of a TDLS peer could be used without departing from the scope of this disclosure.

As illustrated in FIG. 6, STA1 may attempt to transmit to STA2. However, at that time, STA2 may not be available. For example, STA2 may be in doze state, and hence, miss the frames transmitted by STA1 during the R-TWT SP.

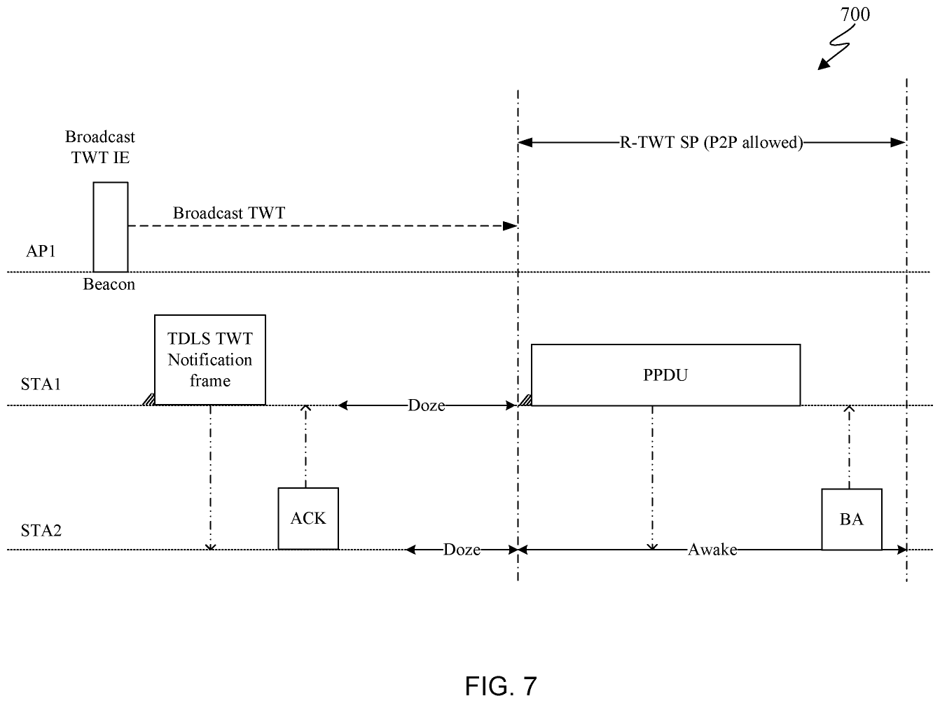

FIG. 7 illustrates an example 700 of the usage of the TDLS TWT notification frame according to embodiments of the present disclosure. The embodiment of the example 700 of the usage of the TDLS TWT notification frame shown in FIG. 7 is for illustration only. Other embodiments of the example 700 of the usage of the TDLS TWT notification frame could be used without departing from the scope of this disclosure.

As illustrated in FIG. 7, according to one embodiment, if a first STA becomes a member of a first R-TWT schedule that allows P2P communication by the first STA during the corresponding R-TWT SP, and if the first STA intends to transmit frames to a second peer STA during the R-TWT SP corresponding to the first R-TWT schedule, then before the R-TWT SP starts, the first STA can send a TDLS TWT Notification frame to the second STA. The TDLS TWT Notification frame would carry information pertaining to the first R-TWT schedule. According to one embodiment, the information pertaining to the first R-TWT schedule can be carried by including a TWT element in the TDLS TWT Notification frame containing the TWT schedule information. According to another embodiment, the information pertaining to the first R-TWT schedule can be carried by including a TDLS TWT Notification element in the TDLS TWT Notification frame. The TDLS TWT Notification element can contain information that would identify the TWT schedule during which the first STA intends to transmit frames to the second STA. For example, the TDLS TWT Notification element can contain Broadcast TWT ID of the R-TWT schedule—during the R-TWT SP corresponding to the R-TWT schedule, the first STA intends to transmit frames to the second STA.

In reference to the embodiment described above illustrated in FIG. 7, the first STA can send the TDLS TWT Notification frame to the second STA if the first STA has latency-sensitive traffic for the second STA.

According to one embodiment, if a first STA establishes a TDLS direct link with a second STA, and if the first STA receives a TDLS TWT Notification frame from the second STA, then the first STA is expected to remain awake during the TWT SPs corresponding to the R-TWT schedule or B-TWT schedule the information of which is carried in the TDLS TWT Notification frame. During the TWT SPs corresponding to the R-TWT or B-TWT schedule whose information is carried in the TDLS TWT Notification frame, the first STA is expected to receive frames from the second STA.

According to one embodiment, if a first STA establishes a TDLS direct link with a second STA, and if the first STA receives a TDLS TWT Notification frame from the second STA, if the TDLS TWT Notification frame contains information pertaining to an R-TWT or B-TWT schedule identified, for example, by the Broadcast TWT ID subfield in the TDLS TWT Notification frame, then the first STA monitors (and decode the corresponding TWT element) the TWT schedule advertised by the AP with which the first STA is associated. By monitoring the TWT schedule, the first STA would remain aware of any changes made to the schedule's parameters by the AP.

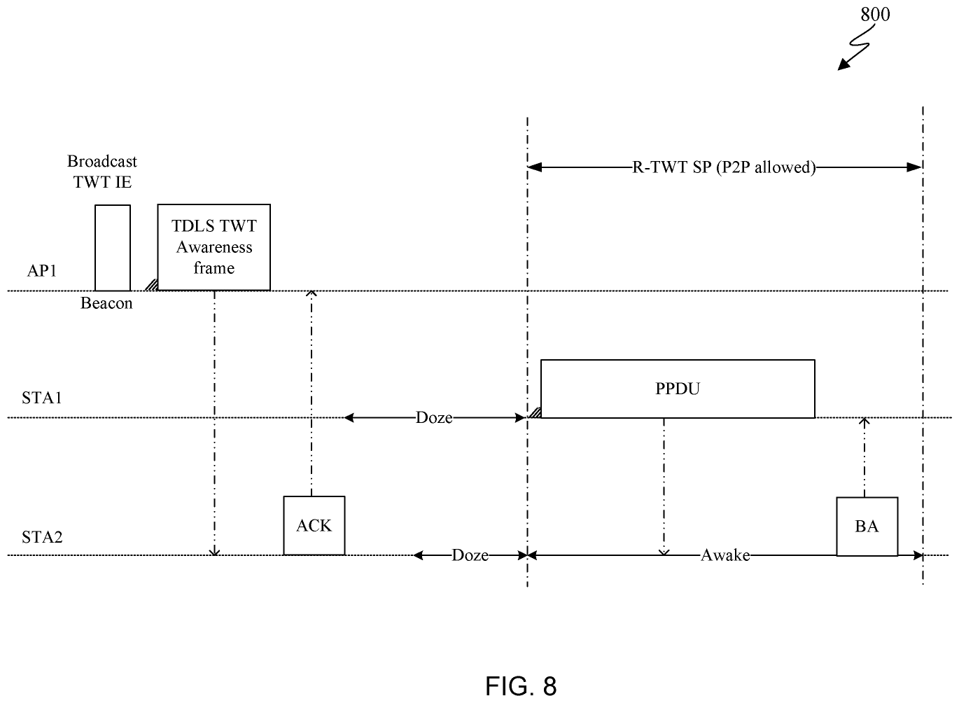

FIG. 8 illustrates an example 800 of the usage of the TDLS TWT awareness frame according to embodiments of the present disclosure. The embodiment of the example 800 of the usage of the TDLS TWT awareness frame shown in FIG. 8 is for illustration only. Other embodiments of the example 800 of the usage of the TDLS TWT awareness frame could be used without departing from the scope of this disclosure.

As illustrated in FIG. 8, according to one embodiment, if a first STA is associated with an AP and becomes a member of a first R-TWT schedule that allows P2P communication by the first STA during the corresponding R-TWT SP, then before the R-TWT SP starts, the AP can send a TDLS TWT Notification frame to the second STA. The TDLS TWT Awareness frame would carry information pertaining to the first R-TWT schedule and may also carry the association identifier information (AID) of the first STA. According to one embodiment, the information pertaining to the first R-TWT schedule can be carried by including a TWT element in the TDLS TWT Awareness frame containing the TWT schedule information. According to another embodiment, the information pertaining to the first R-TWT schedule can be carried by including a TDLS TWT Notification element in the TDLS TWT Awareness frame. The TDLS TWT Notification element can contain information that would identify the TWT schedule during which the first STA intends to transmit frames to the second STA. For example, the TDLS TWT Notification element can contain the Broadcast TWT ID of the R-TWT schedule-during the R-TWT SP corresponding to the R-TWT schedule, the first STA intends to transmit frames to the second STA.

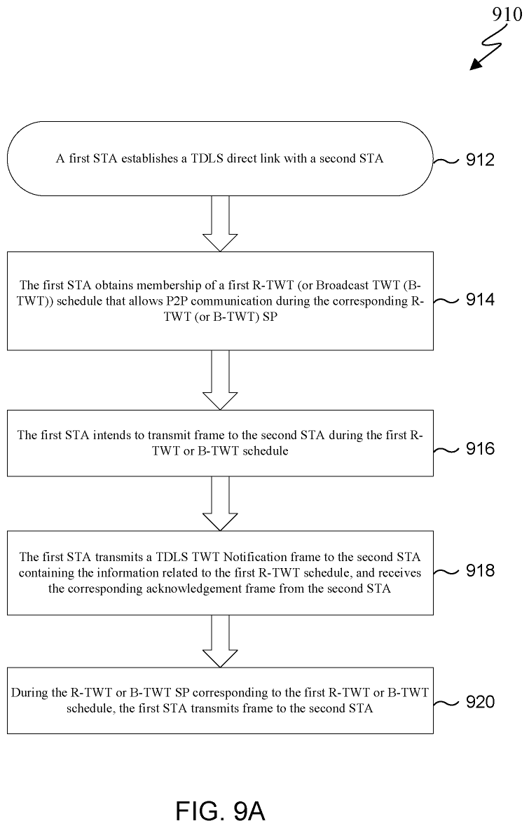

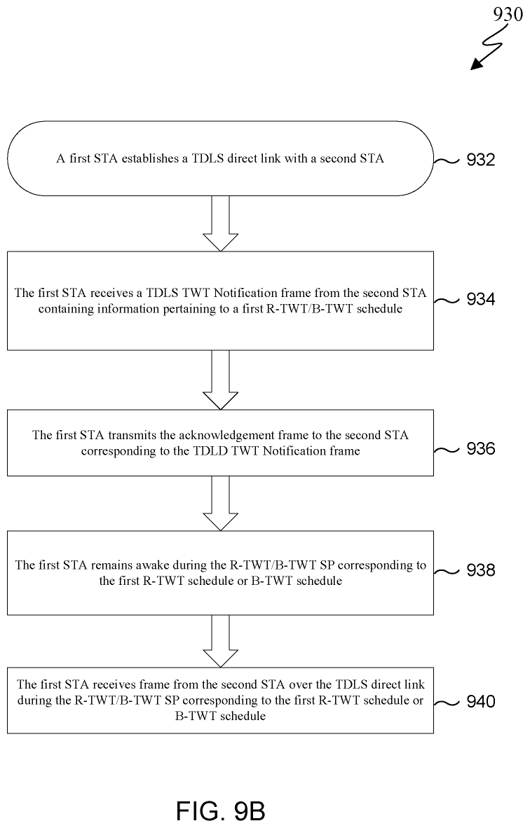

FIG. 9A illustrates an example method 910 for the usage of the TDLS TWT notification frame by a STA that is a member of the R-TWT schedule according to embodiments of the present disclosure. The embodiment of the example method 910 for the usage of the TDLS TWT notification frame by a STA that is a member of the R-TWT schedule shown in FIG. 9A is for illustration only. Other embodiments of the example method 910 for the usage of the TDLS TWT notification frame by a STA that is a member of the R-TWT schedule could be used without departing from the scope of this disclosure.

As illustrated in FIG. 9A, the method begins at step 912, where a first STA establishes a TDLS direct link with a second STA. At step 914, the first STA obtains membership of a first R-TWT or Broadcast TWT (B-TWT)) schedule that allows P2P communication during the corresponding R-TWT (or B-TWT) SP. At step 916, the first STA intends to transmit a frame to the second STA during the first R-TWT or B-TWT schedule. At step 918, the first STA transmits a TDLS TWT Notification frame to the second STA containing the information related to the first R-TWT schedule, and receives the corresponding acknowledgement frame from the second STA. At step 920, during the R-TWT or B-TWT SP corresponding to the first R-TWT or B-TWT schedule, the first STA transmits the frame to the second STA.

FIG. 9B illustrates an example method 930 for the behavior of a TDLS peer STA that receives a TDLS TWT notification frame from its peer STA according to embodiments of the present disclosure. The embodiment of the example method 930 for the behavior of a TDLS peer STA that receives a TDLS TWT notification frame from its peer STA shown in FIG. 9b is for illustration only. Other embodiments of the example method 930 for the behavior of a TDLS peer STA that receives a TDLS TWT notification frame from its peer STA could be used without departing from the scope of this disclosure.

As illustrated in FIG. 9b, the method begins at step 932, where a first STA establishes a TDLS direct link with a second STA. At step 934, the first STA receives a TDLS TWT Notification frame from the second STA containing information pertaining to a first R-TWT/B-TWT schedule. At step 936, the first STA transmits the acknowledgement frame to the second STA corresponding to the TDLD TWT Notification frame. At step 938, the first STA remains awake during the R-TWT/B-TWT SP corresponding to the first R-TWT schedule or B-TWT schedule. At step 940, the first STA receives frame from the second STA over the TDLS direct link during the R-TWT/B-TWT SP corresponding to the first R-TWT schedule or B-TWT schedule.

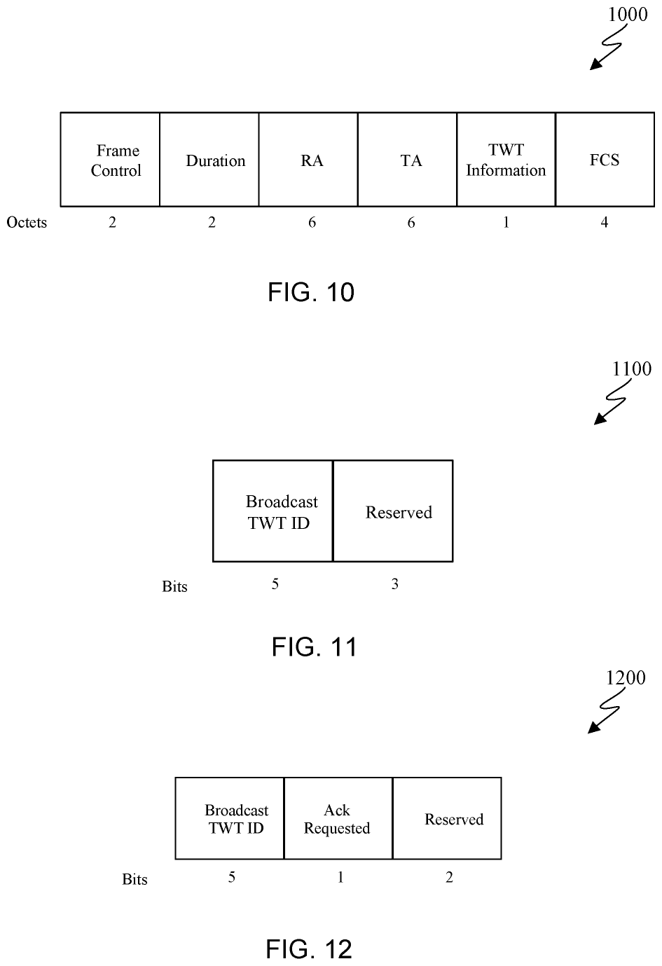

FIG. 10 illustrates an example format 1000 for the TDLS TWT notification frame according to embodiments of the present disclosure. The embodiment of the example format 1000 for the TDLS TWT notification frame shown in FIG. 10 is for illustration only. Other embodiments of the example format 1000 for the TDLS TWT notification frame could be used without departing from the scope of this disclosure.

As illustrated in FIG. 10, the RA field is set to the MAC address of the intended receiver of the TDLS TWT Notification frame, and the TA field is set to the MAC address of the transmitter of the TDLS TWT Notification frame.

FIG. 11 illustrates an example format 1100 for the TDLS information field in the TDLS TWT notification frame according to embodiments of the present disclosure. The embodiment of the example format 1100 for the TDLS information field in the TDLS TWT notification frame shown in FIG. 11 is for illustration only. Other embodiments of the example format 1100 for the TDLS information field in the TDLS TWT notification frame could be used without departing from the scope of this disclosure.

As illustrated in FIG. 11, the Broadcast TWT ID subfield in the TWT Information field identifies the Broadcast TWT ID corresponding to the R-TWT schedule or the broadcast TWT schedule during which the recipient TDLS peer STA is expected to receive a frame from its peer STA as identified by the RA field of the TDLS TWT Notification frame.

FIG. 12 illustrates another example format 1200 for the TDLS information field in the TDLS TWT notification frame according to embodiments of the present disclosure. The embodiment of the example format 1200 for the TDLS information field in the TDLS TWT notification frame shown in FIG. 12 is for illustration only. Other embodiments of the example format 1100 for the TDLS information field in the TDLS TWT notification frame could be used without departing from the scope of this disclosure.

As illustrated in FIG. 12, the Broadcast TWT ID subfield in the TWT Information field identifies the Broadcast TWT ID corresponding to the R-TWT schedule or the broadcast TWT schedule during which the recipient TDLS peer STA is expected to receive a frame from its peer STA as identified by the RA field of the TDLS TWT Notification frame. The Ack Requested subfield is set to 1 if an acknowledgment is requested upon receipt of the TDLS TWT Notification frame; otherwise, the subfield is set to 0.

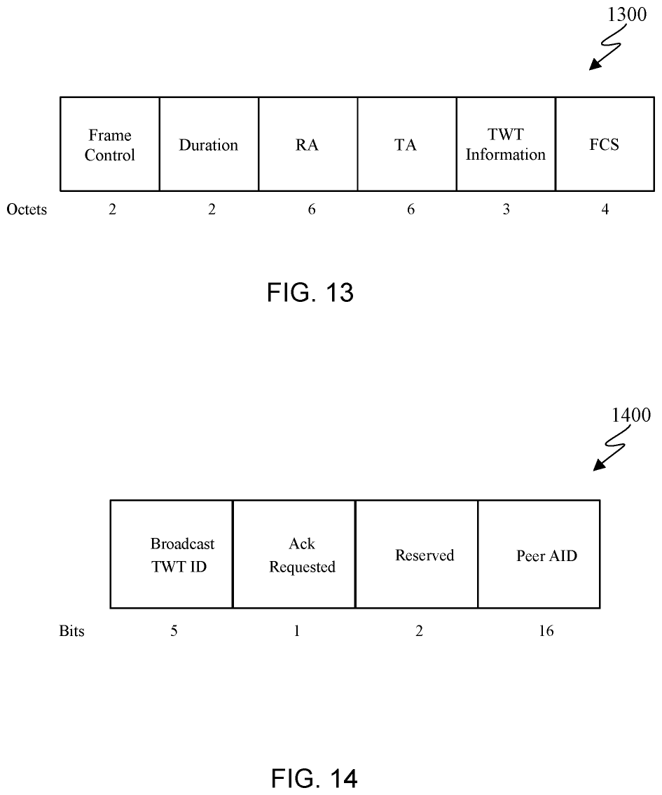

FIG. 13 illustrates an example format 1300 for the TDLS TWT awareness frame according to embodiments of the present disclosure. The embodiment of the example format 1300 for the TDLS TWT awareness frame shown in FIG. 13 is for illustration only. Other embodiments of the example format 1300 for the TDLS TWT awareness frame could be used without departing from the scope of this disclosure.

As illustrated in FIG. 13, the RA field is set to the MAC address of the intended receiver of the TDLS TWT Awareness frame, and the TA field is set to the MAC address of the transmitter of the TDLS TWT Awareness frame. The format of the TWT Information field in the TDLS TWT Awareness frame is shown in FIG. 14.

FIG. 14 illustrates an example format 1400 for the TWT information field of the TDLS TWT awareness frame according to embodiments of the present disclosure. The embodiment of the example format 1400 for the TWT information field of the TDLS TWT awareness frame shown in FIG. 14 is for illustration only. Other embodiments of the example format 1400 for the TWT information field of the TDLS TWT awareness frame could be used without departing from the scope of this disclosure.

As illustrated in FIG. 14, the Broadcast TWT ID subfield in the TWT Information field identifies the Broadcast TWT ID corresponding to the R-TWT schedule or the broadcast TWT schedule during which the recipient TDLS peer STA is expected to receive a frame from its peer STA as identified by the Peer AID subfield of the TWT Information field. The Ack Requested subfield is set to 1 if an acknowledgment is requested upon receipt of the TDLS TWT Awareness frame; otherwise, the subfield is set to 0. The Peer AID subfield indicates the AID of the peer STA that is a member of the R-TWT schedule or broadcast TWT schedule identified by the Broadcast TWT ID subfield of the TDLS TWT Awareness frame, and during the R-TWT SP or Broadcast TWT SP corresponding to the R-TWT schedule or broadcast TWT schedule, the TDLS peer STA, which is the recipient of the TDLS TWT Awareness frame, is expected to receive frames from the peer STA that is the member of the schedule.

According to one embodiment, the TDLS TWT Notification frame can be a TDLS Action frame. Based on this, a possible format of the TDLS TWT Notification Action field is shown in Table I.

TABLE I
Information for TDLS TWT Notification Action field

| Order | Information | Notes |
|---|---|---|
| 1 | Category | The Category field is defined in 9.4.1.11 |
| | | (Action field). |
| 2 | TDLS Action | The TDLS Action field is defined in the |
| | | 802.11 specification [2]. |
| 3 | Link Identifier | The Link Identifier element is specified |
| | | in clause 9.4.2.61 (Link Identifier |
| | | element) of the 802.11 specifications [2]. |
| 4 | TDLS TWT | Contains the TWT information. |
| | Notification | |

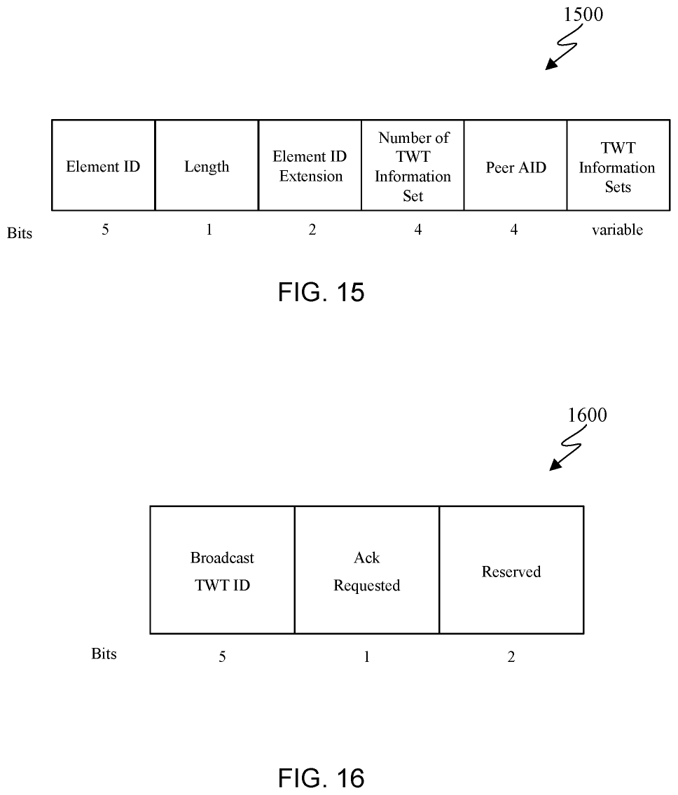

In Table I, one embodiment of a format for the TDLS TWT Notification element in the TDLS TWT Notification Action field is shown in FIG. 15.

FIG. 15 illustrates an example format 1500 for the TDLS TWT notification element according to embodiments of the present disclosure. The embodiment of the example format 1500 for the TDLS TWT notification element shown in FIG. 15 is for illustration only. Other embodiments of the example format 1500 for the TDLS TWT notification element could be used without departing from the scope of this disclosure.

As illustrated in FIG. 15, the Element ID, Length, and Element ID Extension fields are defined in clause 9.4.2.1 of the 802.11 specifications [2]. The Number of TWT Information Set field indicates the number of TWT Information fields present in the TWT Information Sets field of the TDLS TWT Notification element. The Peer AID subfield identifies the AID of the TDLS peer STA that is the member of the Broadcast TWT schedule(s) or the R-TWT schedule(s) as identified by the Broadcast TWT ID subfield(s) included in the TDLS TWT Notification element. The TWT Information Sets field contains one or more TWT Information fields. In one embodiment, a possible format of the TWT Information field is shown in FIG. 16.

FIG. 16 illustrates an example format 1600 for the TWT information field in the TDLS TWT notification element according to embodiments of the present disclosure. The embodiment of the example format 1600 for the TWT information field in the TDLS TWT notification element shown in FIG. 16 is for illustration only. Other embodiments of the example format 1600 for the TWT information field in the TDLS TWT notification element could be used without departing from the scope of this disclosure.

As illustrated in FIG. 16, the TWT information field may include a Broadcast TWT ID field and an Ack Re quested field.

In one embodiment, a format of the Element IDs field containing the TDLS TWT Notification element is shown in Table II.

TABLE II
Element IDs

| | Element | Element ID | Exten- | Fragment- |
|---|---|---|---|---|
| Element | ID | Extension | sible | able |
| TDLS TWT Notification | 255 | <ANA> | Yes | Yes |

According to one embodiment, the TDLS TWT Notification frame can be a Protected EHT Action frame. Based on this, a possible format of the TDLS TWT Notification frame Action field is shown in Table III.

TABLE III
Protected TDLS TWT Notification frame Action field format

| Order | Information |
|---|---|
| 1 | Category |
| 2 | Protected EHT Action |
| 3 | Dialog Token |
| 4 | TDLS TWT Notification |

The Protected EHT Action field values containing the TDLS TWT Notification frame is shown in Table IV.

TABLE IV
Protected EHT Action field values

| Value | Meaning | Time priority |
|---|---|---|
| 0 | TID-To-Link Mapping Request | No |
| 1 | TID-To-Link Mapping Response | No |
| 2 | TID-To-Link Mapping Teardown | No |
| 3 | EPCS Priority Access Enable Request | No |
| 4 | EPCS Priority Access Enable Response | No |
| 5 | EPCS Priority Access Teardown | No |
| 6 | EML Operating Mode Notification | No |
| 7 | Link Recommendation | No |
| 8 | Multi-Link Operation Update Request | No |
| 9 | Multi-Link Operation Update Response | No |
| 10 | TDLS TWT Notification | No |
| 11-255 | Reserved | |

According to one embodiment, the TDLS TWT Notification element can also be contained in the TDLS Discovery Request frame, TDLS Discovery Response frame, TDLS Setup Request frame, TDLS Setup Response frame, and TDLS Setup Confirmation frame.

According to one embodiment, the TDLS TWT Awareness frame can also be a TDLS Action frame or an EHT Action frame. The format can be the same as that described for the TDLS TWT Notification frame.

According to one embodiment, the embodiment described in the disclosure can also be applicable to individual TWT. In that case, the instead of Broadcast TWT ID subfield, a TWT Flow Identifier can be used in the frames and elements described in the disclosure to identify the individual TWT during which the frame/element recipient is expected to receive frames from its TDLS peer STA.

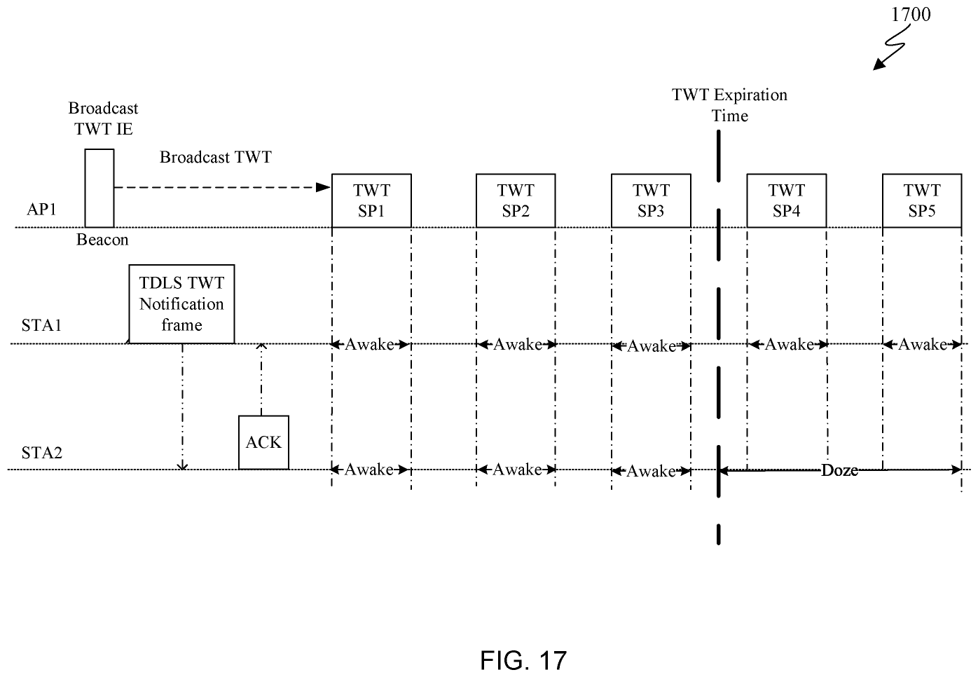

According to one embodiment, when a first STA that is a member of an R-TWT schedule or a broadcast TWT schedule sends a TDLS TWT Notification frame to a TDLS peer STA (the second STA), then the first STA can indicate the time (TWT Expiration Time) until when the first STA intends to transmit a frame to the second STA during a TWT SP corresponding to the R-TWT or B-TWT schedule whose information is carried in the TDLS TWT Notification frame. Upon reception of the TDLS TWT Notification frame, the second STA would know how long it needs to monitor (and decode the corresponding TWT element) the R-TWT schedule or B-TWT schedule and advertised by the AP with which both the first and the second STAs are associated. For example, after the expiration of TWT Expiration Time, the second STA may go to a doze state and is not expected to remain awake during a TWT SP corresponding to the R-TWT or B-TWT schedule whose information is carried in the TDLS TWT Notification frame. According to one embodiment, instead of indicating the time, the first STA can indicate the number of service periods (SPs), e.g., indicated by the SP Expiration Count subfield, corresponding to the R-TWT or B-TWT schedule for which the first STA intends to transmit a frame to the second STA during a TWT SP corresponding to the R-TWT or B-TWT schedule. After the number of SPs as indicated by the SP Expiration Could subfield has passed since the reception of the TDLS TWT Notification frame, the second STA is no longer expected to receive frames from the first STA during the R-TWT or B-TWT SP and can remain in doze state, if the second STA chooses, during the SPs. This embodiment is illustrated in FIG. 17.

FIG. 17 illustrates an example 1700 of TDLS TWT notification expiration according to embodiments of the present disclosure. The embodiment of the example 1700 of TDLS TWT notification expiration shown in FIG. 17 is for illustration only. Other embodiments of the example 1700 of TDLS TWT notification expiration could be used without departing from the scope of this disclosure.

As illustrated in FIG. 17, STA1 is a member of the R-TWT schedule and sends the TDLS TWT Notification frame to STA2. In the TDLS TWT Notification frame, STA1 indicates that it intends to transmit to STA during the TWT SP until the time indicated by the TWT Expiration Time subfield in the TDLS TWT Notification frame or element. After the expiration of the time indicated by the TWT Expiration Time, the second STA goes to doze and it remains in doze state in the subsequent TWT SP (TWT SP 4 and TWT SP 5).

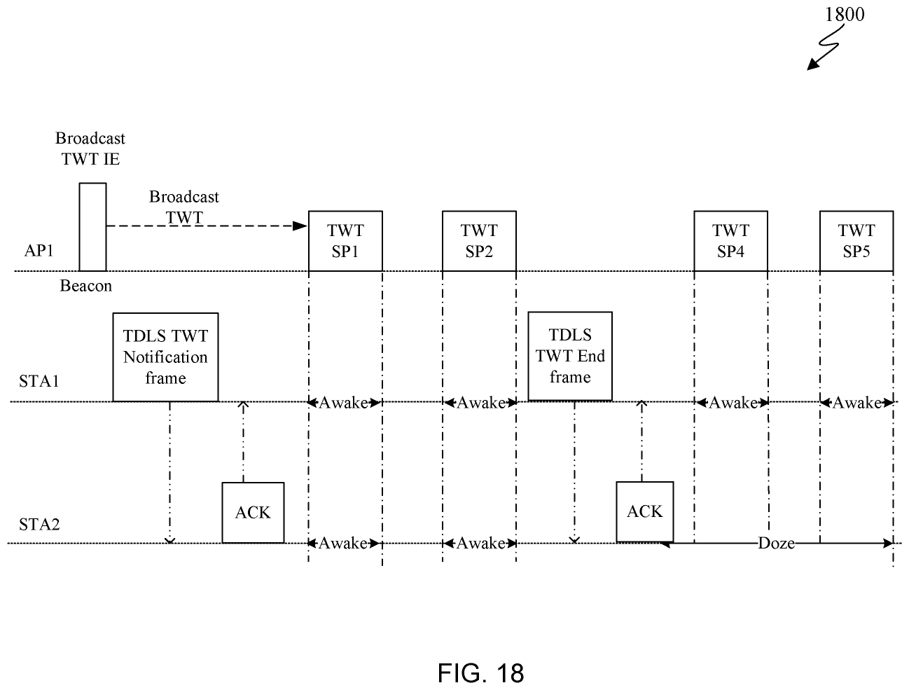

FIG. 18 illustrates an example 1800 of the termination of the TDLS TWT awareness requirement according to embodiments of the present disclosure. The embodiment of the example 1800 of the termination of the TDLS TWT awareness requirement shown in FIG. 17 is for illustration only. Other embodiments of the example 1800 of the termination of the TDLS TWT awareness requirement could be used without departing from the scope of this disclosure.

According to one embodiment, when a first STA that is a member of an R-TWT schedule or a broadcast TWT schedule sends a TDLS TWT Notification frame to a TDLS peer STA (the second STA) at a time T1, then the first STA can indicate to the second STA that it does no longer intend to transmit frames to the second STA during an R-TWT or B-TWT SP corresponding to the R-TWT or B-TWT schedule indicated in the TDLS TWT Notification frame by sending a TDLS TWT End frame to the second STA. Upon successful reception of the TDLS TWT End frame by the second STA, the second STA is no longer expected to receive frames from the first STA during the R-TWT or B-TWT SP corresponding to the R-TWT or B-TWT schedule and may remain in doze state in the subsequent TWT SPs. This embodiment is illustrated in FIG. 18. The second STA can monitor the TWT schedule whose information is carried in the TDLS TWT Notification frame until the reception of the TDLS TWT End frame or until the expiration of the time indicated by the TWT Expiration Time, whichever comes first.

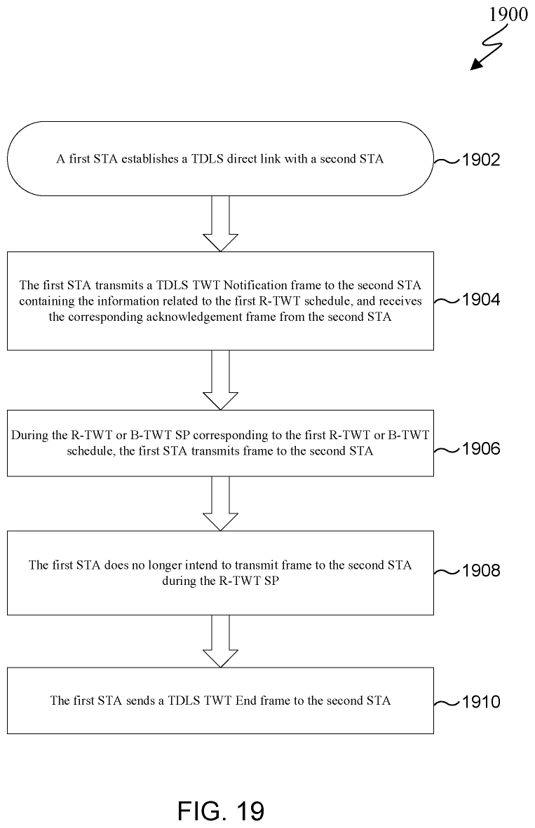

FIG. 19 illustrates an example method 1900 for the usage of the TDLS end frame according to embodiments of the present disclosure. The embodiment of the example method 1900 for the usage of the TDLS end frame shown in FIG. 19 is for illustration only. Other embodiments of the example method 1900 for the usage of the TDLS end frame could be used without departing from the scope of this disclosure.

As illustrated in FIG. 19, the method 1900 begins at step 1902, where a first STA establishes a TDLS direct link with a second STA. At step 1904, the first STA transmits a TDLS TWT Notification frame to the second STA containing the information related to the first R-TWT schedule, and receives the corresponding acknowledgement frame from the second STA. At step 1906, during the R-TWT or B-TWT SP corresponding to the first R-TWT or B-TWT schedule, the first STA transmits frame to the second STA. At step 1908, the first STA does no longer intend to transmit frame to the second STA during the R-TWT SP. At step 1910, the first STA sends a TDLS TWT End frame to the second STA.

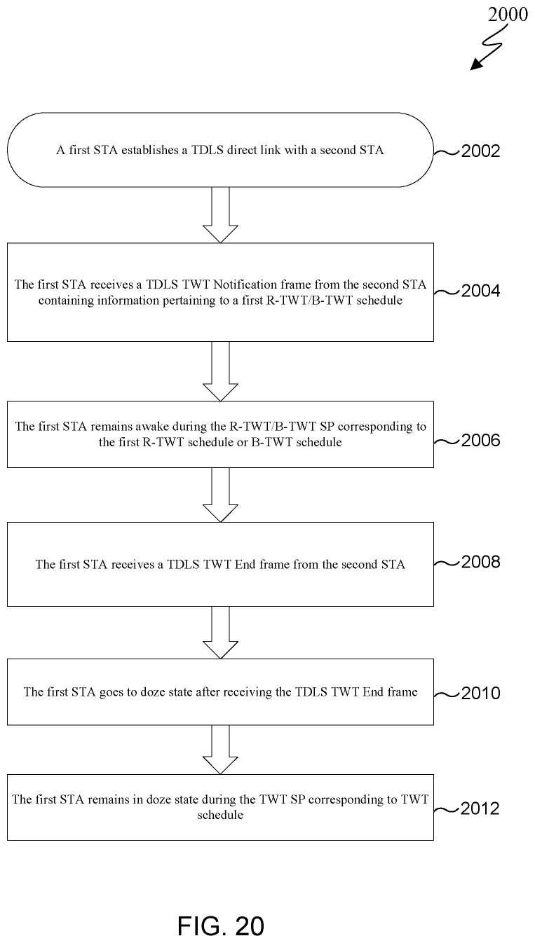

FIG. 20 illustrates an example method 2000 for the behavior of a TDLS peer STA upon receiving the TDLS TWT according to embodiments of the present disclosure. The embodiment of the example method 2000 for the behavior of a TDLS peer STA upon receiving the TDLS TWT shown in FIG. 20 is for illustration only. Other embodiments of the example method 2000 for the behavior of a TDLS peer STA upon receiving the TDLS TWT could be used without departing from the scope of this disclosure.

As illustrated in FIG. 20, the method 2000 begins at step 2002, where a first STA establishes a TDLS direct link with a second STA. At step 2004, the first STA receives a TDLS TWT Notification frame from the second STA containing information pertaining to a first R-TWT/B-TWT schedule. At step 2006, the first STA remains awake during the R-TWT/B-TWT SP corresponding to the first R-TWT schedule or B-TWT schedule. At step 2008, the first STA receives a TDLS TWT End frame from the second STA. At step 2010, the first STA goes to a doze state after receiving the TDLS TWT End frame. At step 2012, the first STA remains in the doze state during the TWT SP corresponding to TWT schedule.

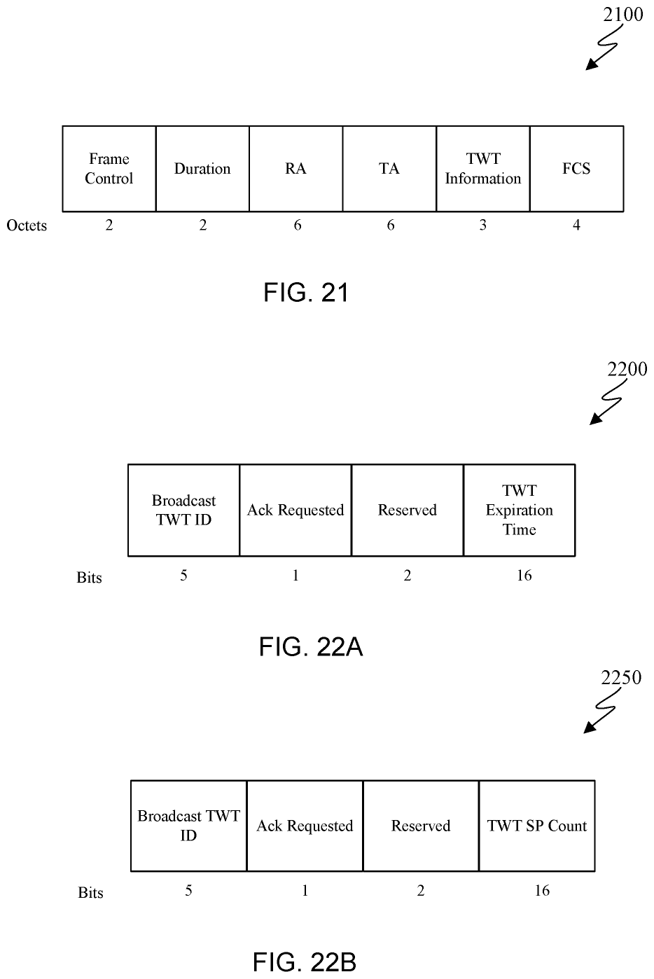

FIG. 21 illustrates an example format 2100 for the TDLS TWT notification frame according to embodiments of the present disclosure. The embodiment of the example format 2100 for the TDLS TWT notification frame shown in FIG. 21 is for illustration only. Other embodiments of the example format 2100 for the TDLS TWT notification frame could be used without departing from the scope of this disclosure.

According to one embodiment, a possible format for the TDLS TWT Notification frame that contains the TWT Expiration Time subfield is shown in FIG. 21, where the TDLS TWT Notification frame is a Control frame.

As illustrated in FIG. 21, the RA field is set to the MAC address of the intended receiver of the TDLS TWT Notification frame, and the TA field is set to the MAC address of the transmitter of the TDLS TWT Notification frame.

FIG. 22A illustrates an example format 2200 for the TWT information field in the TDLS TWT notification frame according to embodiments of the present disclosure. The embodiment of the example format 2200 for the TWT information field in the TDLS TWT notification frame shown in FIG. 22A is for illustration only. Other embodiments of the example format 2200 for the TWT information field in the TDLS TWT notification frame could be used without departing from the scope of this disclosure.

As illustrated in FIG. 22A, the Broadcast TWT ID subfield in the TWT Information field identifies the Broadcast TWT ID corresponding to the R-TWT schedule or the broadcast TWT schedule during which the recipient TDLS peer STA is expected to receive a frame from its peer STA as identified by the RA field of the TDLS TWT Notification frame. The Ack Requested subfield is set to 1 if an acknowledgment is requested upon receipt of the TDLS TWT Notification frame; otherwise, the subfield is set to 0. The TWT Expiration Time subfield indicates the time until when the recipient STA is expected to receive frames from the peer STA during the TWT SPs corresponding to the TWT schedule whose information is carried in the TDLS TWT Notification frame.

FIG. 22B illustrates an example format 2250 for the TDLS TWT notification frame including the TWT SP count subfield according to embodiments of the present disclosure. The embodiment of the example format 2250 for the TDLS TWT notification frame including the TWT SP count subfield shown in FIG. 22B is for illustration only. Other embodiments of the example format 2250 for the TDLS TWT notification frame including the TWT SP count subfield could be used without departing from the scope of this disclosure.

As illustrated in FIG. 22b, the TWT SP Count subfield indicates the number of TWT SP since the reception of the TDLS TWT Notification frame for which the TDLS peer STA that is the recipient of the TDLS TWT Notification frame is expected to receive frames from its peer STA during the TWT SP corresponding to the TWT schedule whose information is carried in the TDLS TWT Notification frame.

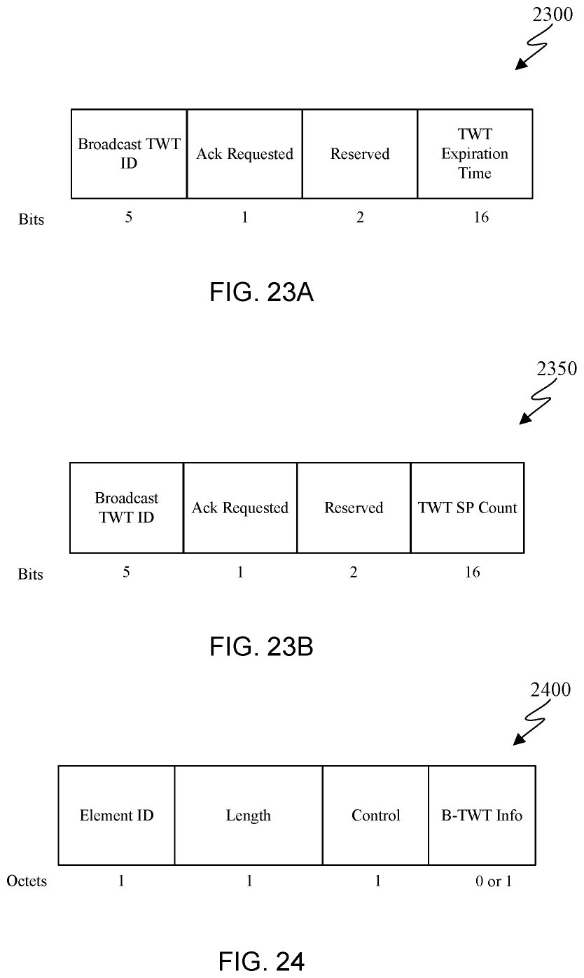

FIG. 23A illustrates an example format 2300 for the TWT information field in the TDLS TWT notification element containing the TWT expiration time according to embodiments of the present disclosure. The embodiment of the example format 2300 for the TWT information field in the TDLS TWT notification element containing the TWT expiration time shown in FIG. 23a is for illustration only. Other embodiments of the example format 2300 for the TWT information field in the TDLS TWT notification element containing the TWT expiration time could be used without departing from the scope of this disclosure.

As illustrated in FIG. 23A, the TWT information field may include a Broadcast TWT ID field and an Ack Re quested field.

FIG. 23B illustrates an example format 2350 for the TDLS TWT notification frame including the TWT SP count subfield according to embodiments of the present disclosure. The embodiment of the example format 2350 for the TDLS TWT notification frame including the TWT SP count subfield shown in FIG. 23b is for illustration only. Other embodiments of the example format 2350 for the TDLS TWT notification frame including the TWT SP count subfield could be used without departing from the scope of this disclosure.

As illustrated in FIG. 23B, the TWT SP Count subfield indicates the number of TWT SP since the reception of the TDLS TWT Notification frame for which the TDLS peer STA that is the recipient of the TDLS TWT Notification frame is expected to receive frames from its peer STA during the TWT SP corresponding to the TWT schedule whose information is carried in the TDLS TWT Notification frame.

According to one embodiment, the TDLS TWT End frame can be a TDLS Action frame. Based on this, a possible format of the TDLS TWT End Action field is shown in Table V.

TABLE V
Information for TDLS TWT End Action field

| Order | Information | Notes |
|---|---|---|
| 1 | Category | The Category field is defined in 9.4.1.11 (Action |
| | | field). |
| 2 | TDLS | The TDLS Action field is defined in the 802.11 |
| | Action | specification [2]. |
| 3 | Link | The Link Identifier element is specified in clause |
| | Identifier | 9.4.2.61 (Link Identifier element) of the 802.11 |
| | | specifications [2]. |
| 4 | TDLS TWT | Contains the TWT information. |
| | Notification | |

A possible format of the Element IDs field containing the TDLS TWT Notification element is shown in Table VI.

TABLE VI
Element IDs

| | Element | Element ID | Exten- | Fragment- |
|---|---|---|---|---|
| Element | ID | Extension | sible | able |
| TDLS TWT End | 255 | <ANA> | Yes | Yes |

According to one embodiment, the TDLS TWT End frame can be a Protected EHT Action frame. Based on this, a possible format of the TDLS TWT End frame Action field is shown in Table VII.

TABLE VII
Protected TDLS TWT End frame Action field format

| Order | Information |
|---|---|
| 1 | Category |
| 2 | Protected EHT Action |
| 3 | Dialog Token |
| 4 | TDLS TWT Notification |

The Protected EHT Action field values containing the TDLS TWT End frame are shown in Table VIII.

TABLE VIII
Protected EHT Action field values

| Value | Meaning | Time priority |
|---|---|---|
| 0 | TID-To-Link Mapping Request | No |
| 1 | TID-To-Link Mapping Response | No |
| 2 | TID-To-Link Mapping Teardown | No |
| 3 | EPCS Priority Access Enable Request | No |
| 4 | EPCS Priority Access Enable Response | No |
| 5 | EPCS Priority Access Teardown | No |
| 6 | EML Operating Mode Notification | No |
| 7 | Link Recommendation | No |
| 8 | Multi-Link Operation Update Request | No |
| 9 | Multi-Link Operation Update Response | No |
| 10 | TDLS TWT End | No |
| 11-255 | Reserved | |

According to one embodiment, if a TDLS peer STA that is a member of a broadcast TWT schedule intends to transmit frames to another TDLS peer STA over a TDLS direct link during the TWT SP corresponding to the broadcast TWT schedule, then the TDLS peer STA may send a TDLS Broadcast TWT Request frame to the other TDLS peer STA, where the broadcast TWT schedule is identified by the Broadcast TWT ID subfield in the TWT Information Extension element in the TDLS Broadcast TWT Request frame. If the other TDLS peer STA, upon reception of the TDLS Broadcast TWT Request frame, responds by transmitting a TDLS Broadcast TWT Response frame with the status code SUCCESS, then the other TDLS peer STA is expected to be in the Awake state during the TWT SPs corresponding to the broadcast TWT schedule. In the TDLS Broadcast TWT Response frame, the Broadcast TWT ID subfield value in the TWT Information Extension element shall be the same as that in TDLS Broadcast TWT Request frame.

According to one embodiment, before obtaining membership to a broadcast TWT schedule for TDLS operation (see 35.3.21.1), the TWT scheduled STA needs to ensure that the TDLS peer STA is available during the TWT SPs corresponding to that broadcast TWT schedule.

According to one embodiment, the name of the information element containing the broadcast TWT schedule information can be the TWT Information Extension element. According to this embodiment, the format of the TWT Information Extension element is shown in FIG. 24.

FIG. 24 illustrates an example format 2400 for the TWT information extension element according to embodiments of the present disclosure. The embodiment of the example format 2400 for the TWT information extension element shown in FIG. 24 is for illustration only. Other embodiments of the example format 2400 for the TWT information extension element could be used without departing from the scope of this disclosure.

The TWT Information Extension element contains information related to a TWT schedule. The element is defined in FIG. 24. The Element ID and Length fields are defined in 9.4.2.1 (General) of [2].

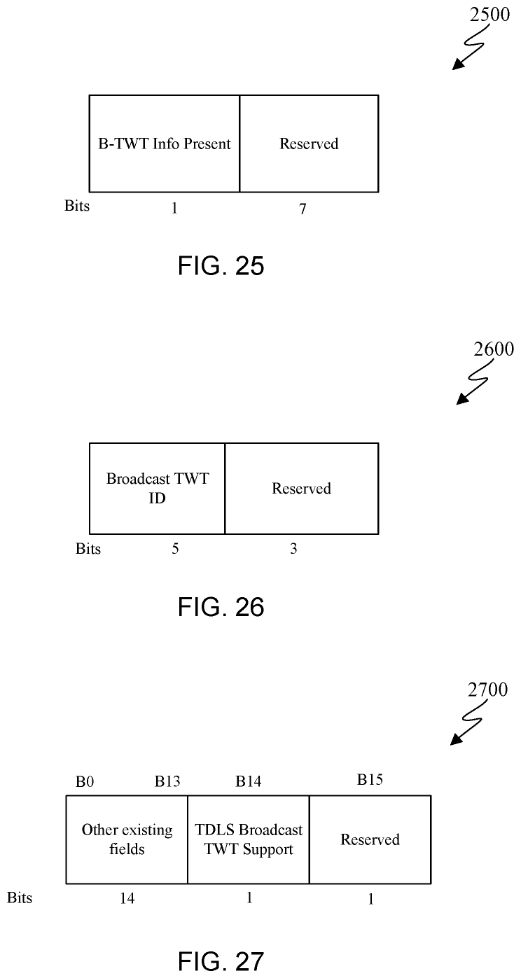

FIG. 25 illustrates an example format 2500 for the control field according to embodiments of the present disclosure. The embodiment of the example format 2500 for the control field shown in FIG. 25 is for illustration only. Other embodiments of the example format 2500 for the control field could be used without departing from the scope of this disclosure.

According to one embodiment, The B-TWT Info Present subfield indicates the presence of the B-TWT Info field in the TWT Information Extension element. The B-TWT Info field is present if the subfield is set to 1; otherwise, it is not present.

FIG. 26 illustrates an example format 2600 for the B-TWT information field according to embodiments of the present disclosure. The embodiment of the example format 2600 for the B-TWT information field shown in FIG. 26 is for illustration only. Other embodiments of the example format 2600 for the B-TWT information field could be used without departing from the scope of this disclosure.

As illustrated in FIG. 26, according to one embodiment, the Broadcast TWT ID subfield in the B-TWT Info field identifies a broadcast TWT schedule advertised by the AP.

TABLE 9-128
Element IDs

| | Element | Element ID | Exten- | Fragment- |
|---|---|---|---|---|
| Element | ID | Extension | sible | able |
| . | . | . | . | . |
| . | . | . | . | . |
| . | . | . | . | . |
| TWT Information | 255 | 136 | Yes | No |
| Extension | | | | |

TABLE 9-498
TDLS Action field values

| Action field value | Meaning |
|---|---|
| . | . |
| . | . |
| . | . |
| 11 | TDLS Broadcast TWT Request |
| 12 | TDLS Broadcast TWT Response |
| 13-255 | Reserved |

According to one embodiment, The TDLS Broadcast TWT Request Action field contains information shown in Table IX (Information for TDLS Broadcast TWT Request Action field).

TABLE IX
Information for TDLS Broadcast TWT Request Action field

| Order | Information | Notes |
|---|---|---|
| 1 | Category | The Category field is defined in 9.4.1.11 |
| | | (Action field) |
| 2 | TDLS | The TDLS Action field is defined in 9.6.12.1 |
| | Action | (TDLS Action Field). |
| 3 | Dialog | The Dialog Token field contains a value that |
| | Token | is unique among TDLS Broadcast TWT Request |
| | | Action fields for which a corresponding TDLS |
| | | Broadcast TWT Response Action field has not |
| | | been received. The dialog token is specified |
| | | in 9.4.1.12 (Dialog Token field). |
| 4 | Link | The Link Identifier element is specified in |
| | Identifier | 9.4.2.60 (Link Identifier element). |
| 5 | TWT | The TWT Information Extension element is |
| | Information | specified in 9.4.2.xx3 (TWT Extension |
| | Extension | Information element). |

According to one embodiment, The TDLS Broadcast TWT Response Action field contains information shown in Table X (Information for TDLS Broadcast TWT Response Action field).

TABLE X
Information for TDLS Broadcast TWT Response Action field

| Order | Information | Notes |
|---|---|---|
| 1 | Category | The Category field is defined in 9.4.1.11 |
| | | (Action field) |
| 2 | TDLS | The TDLS Action field is defined in 9.6.12.1 |
| | Action | (TDLS Action Field) |
| 3 | Dialog | The Dialog Token field is set to a value |
| | Token | contained in the corresponding TDLS Broadcast |
| | | TWT Request Action field. The dialog token is |
| | | specified in 9.4.1.12 (Dialog Token field). |
| 4 | Status | The Status Code is specified in 9.4.1.9 |
| | Code | (Status Code field) |
| 5 | Link | The Link Identifier element is specified in |
| | Identifier | 9.4.2.60 (Link Identifier element). |
| 6 | TWT | The TWT Information Extension element is |
| | Information | specified in 9.4.2.xx3 (TWT Information |
| | Extension | Extension element). |

According to one embodiment, before obtaining membership to a broadcast TWT schedule for TDLS operation (see 35.3.21.1), the TWT scheduled STA needs to ensure that the TDLS peer STA is available during the TWT SPs corresponding to that broadcast TWT schedule.

According to one embodiment, in order to make sure that the peer second STA is available during the broadcast TWT schedule of which a first STA is a member, the first STA may attempt to establish an individual TWT with the second STA, where the parameters of the individual TWT agreement may be matching with the parameters of that broadcast TWT schedule.

According to one embodiment, in order to indicate whether a STA supports this broadcast TWT awareness for TDLS operation as described in this disclosure in the above paragraphs, a capability indication bit can be used. If this capability indication bit is set to 1, it indicates that the STA supports this feature as described in this disclosure. If the Bit is set to 0, it indicates that the STA may not support this feature as described in this disclosure.

FIG. 27 illustrates an example format 2700 for the EHT medium access control (MAC) capabilities information element according to embodiments of the present disclosure. The embodiment of the example format 2700 for the EHT medium access control (MAC) capabilities information element shown in FIG. 27 is for illustration only. Other embodiments of the example format 2700 for the EHT medium access control (MAC) capabilities information element could be used without departing from the scope of this disclosure.

As illustrated in FIG. 27, if the TDLS Broadcast TWT Support subfield in the EHT Capabilities element transmitted by a STA is set to 1, it can indicate that the STA supports the broadcast TWT awareness for TDLS operation as described in this disclosure in the above paragraphs; otherwise, it does not support the broadcast TWT awareness for TDLS operation as described in this disclosure in the above paragraphs.

According to another embodiment, the capability indication bit, whose behavior and usage is described above, can be within the TDLS Multi-Link element. For example, by using a bit from the (currently reserved) Presence Bitmap subfield of the TDLS Multi-Link IE or defining a Capabilities field in the Common Info field of TDLS ML IE and introduce the field TDLS Broadcast TWT Support subfield within the Capabilities field.

According to one embodiment, Capabilities element or the Extended Capabilities element can have a the TDLS broadcast TWT support subfield. For example, a row in Extended Capabilities field in the Extended Capabilities element is shown below:

TABLE 9-190
Extended Capabilities field (continued)

| Bit | Information | Notes |
|---|---|---|
| . . . | | |
| <ANA> | TDLS | The STA sets the TDLS Broadcast TWT Support |
| | Broadcast | field to 1 when the STA sets the Broadcast |
| | TWT | TWT Support field in the HE Capabilities |
| | Support | element it transmits to 1 and the STA supports |
| | | TDLS operation with broadcast TWT as specified |
| | | in 35.3.21.1 (General). |

According to one embodiment, if a TDLS peer STA that is a member of a broadcast TWT schedule intends to transmit frames to another TDLS peer STA over a TDLS direct link during the TWT SP corresponding to the broadcast TWT schedule, then the TDLS peer STA may send a TDLS Broadcast TWT Request frame to the other TDLS peer STA if both of the TDLS peer STAs set the TDLS Broadcast TWT Support field in the Extended Capabilities element they transmit to 1, where the broadcast TWT schedule is identified by the Broadcast TWT ID subfield in the TWT Information Extension element in the TDLS Broadcast TWT Request frame. If the other TDLS peer STA, upon reception of the TDLS Broadcast TWT Request frame, responds by transmitting a TDLS Broadcast TWT Response frame with the status code SUCCESS, then the other TDLS peer STA is expected to be in the Awake state during the TWT SPs corresponding to the broadcast TWT schedule. In the TDLS Broadcast TWT Response frame, the Broadcast TWT ID subfield value in the TWT Information Extension element shall be the same as that in TDLS Broadcast TWT Request frame.

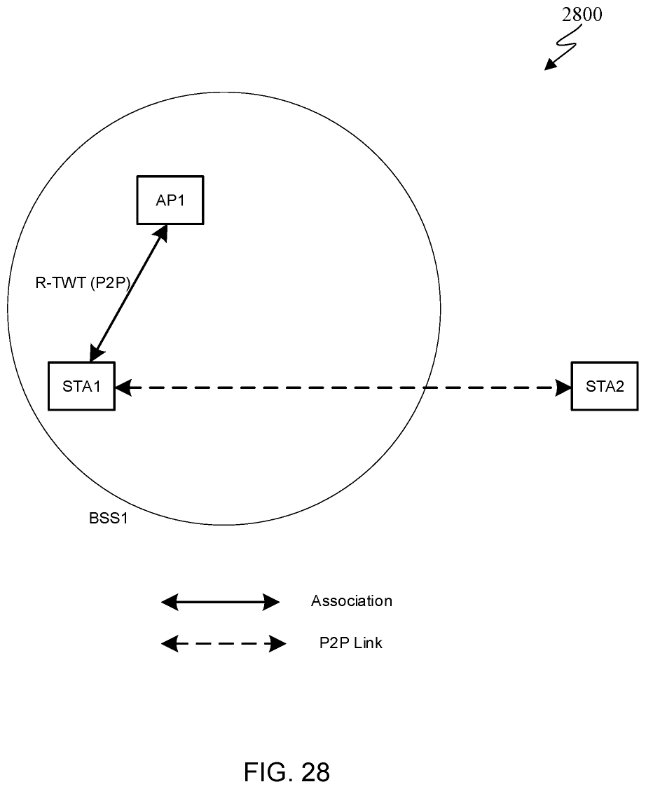

FIG. 28 illustrates an example 2800 of a non-TDLS peer-to-peer (P2P) topology according to embodiments of the present disclosure. The embodiment of the example 2800 of a non-TDLS P2P topology shown in FIG. 9 is for illustration only. Other embodiments of the example 2800 of a non-TDLS P2P topology could be used without departing from the scope of this disclosure.

As illustrated in FIG. 28, according to one embodiment, if a first STA has established a P2P link with a second STA, where the P2P link may or may not be a TDLS direct link (for reference, a non-TDLS P2P topology is illustrated in FIG. 28), if a first STA becomes a member of a first R-TWT schedule that allows P2P communication by the first STA during the corresponding R-TWT SP, and if the first STA intends to transmit frames to the second peer STA during the R-TWT SP corresponding to the first R-TWT schedule, then before the R-TWT SP starts, the first STA can send a P2P TWT Notification frame to the second STA. The format of the P2P TWT Notification frame and P2P TWT Notification element can be the same as that of the TDLS TWT Notification frame and TDLS TWT Notification element, respectively. The behavior of the second STA upon receiving the P2P TWT Notification frame or the P2P TWT Notification element can be the same as the behavior of the second STA upon receiving the TDLS TWT Notification frame and TDLS TWT Notification element as described in the previous embodiments.

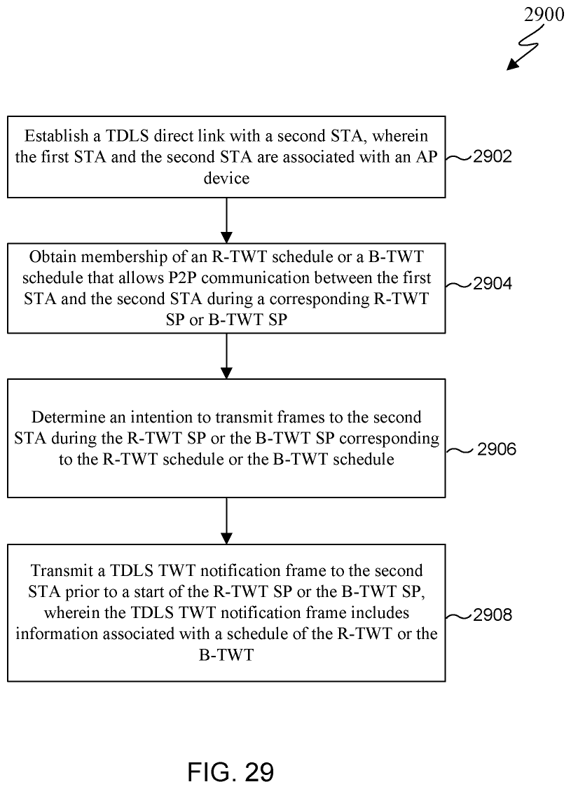

FIG. 29 illustrates a flowchart of a method 2900 for wireless communication performed by a first STA according to embodiments of the present disclosure. The embodiment of the method 2900 shown in FIG. 29 is for illustration only. Other embodiments of the method 2900 could be used without departing from the scope of this disclosure.

As illustrated in FIG. 29, the method 2900 begins at step 2902, where the first STA establishes a TDLS direct link with a second STA, wherein the first STA and the second STA are associated with an AP device. At step 2904, the first STA obtains membership of an R-TWT schedule or a B-TWT schedule that allows P2P communication between the first STA and the second STA during a corresponding R-TWT SP or B-TWT SP. At step 2906, the first STA determines an intention to transmit frames to the second STA during the R-TWT SP or the B-TWT SP corresponding to the R-TWT schedule or the B-TWT schedule. At step 2908, the first STA transmits a TDLS TWT notification frame to the second STA prior to a start of the R-TWT SP or the B-TWT SP, wherein the TDLS TWT notification frame includes information associated with a schedule of the R-TWT or the B-TWT.

In one embodiment, the information associated with the schedule of the R-TWT or the B-TWT is included in a TWT element in the TDLS TWT notification frame or in a TDLS TWT notification element in the TDLS TWT notification frame, and the TDLS TWT notification element includes information that identifies a TWT schedule during which the first STA intends to transmit frames to the second STA.

In one embodiment, the first STA is a member of the B-TWT schedule and intends to transmit frames to the second STA during the B-TWT schedule, and the first STA transmits a TDLS B-TWT request frame to the second STA, wherein the B-TWT schedule is identified by an identification field in an extension element in the TDLS B-TWT request frame.

In one embodiment, the first STA receives a TDLS B-TWT response frame indicating success, wherein the TDLS B-TWT response frame includes an identification field in an extension element, and a value in the identification field in the extension element of the TDLS B-TWT response frame is the same as a value in the identification field in the extension element of the TDLS B-TWT request frame.

In one embodiment, the extension element in the TDLS B-TWT request frame comprises information associated with the schedule of the B-TWT, and the identification field identifies a B-TWT schedule advertised by the AP.

In one embodiment, the TDLS TWT notification frame comprises a TDLS B-TWT request action frame including one or more of a category field, a TDLS action field, a dialog token field, a link identifier field, and a TWT information extension field.

In one embodiment, the TDLS TWT notification frame includes a capability indication field that indicates whether the first STA supports broadcast TWT awareness for a TDLS operation.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first station (STA), the method comprising:
establishing a tunneled direct link setup (TDLS) direct link with a second STA, wherein the first STA and the second STA are associated with an access point (AP) device;
obtaining membership of a restricted target wake time (R-TWT) schedule or a broadcast TWT (B-TWT) schedule that allows peer-to-peer (P2P) communication between the first STA and the second STA during a corresponding R-TWT service period (SP) or B-TWT SP;
determining an intention to transmit frames to the second STA during the R-TWT SP or the B-TWT SP corresponding to the R-TWT schedule or the B-TWT schedule; and
transmitting a TDLS TWT notification frame to the second STA prior to a start of the R-TWT SP or the B-TWT SP, wherein the TDLS TWT notification frame includes information associated with a schedule of the R-TWT or the B-TWT.

2. The method of claim 1, wherein:
the information associated with the schedule of the R-TWT or the B-TWT is included in a TWT element in the TDLS TWT notification frame or in a TDLS TWT notification element in the TDLS TWT notification frame, and
the TDLS TWT notification element includes information that identifies a TWT schedule during which the first STA intends to transmit frames to the second STA.

3. The method of claim 1, wherein the first STA is a member of the B-TWT schedule and intends to transmit frames to the second STA during the B-TWT schedule, the method further comprising:
transmitting a TDLS B-TWT request frame to the second STA, wherein the B-TWT schedule is identified by an identification field in an extension element in the TDLS B-TWT request frame.

4. The method of claim 3, further comprising receiving a TDLS B-TWT response frame indicating success, wherein:
the TDLS B-TWT response frame includes an identification field in an extension element, and
a value in the identification field in the extension element of the TDLS B-TWT response frame is the same as a value in the identification field in the extension element of the TDLS B-TWT request frame.

5. The method of claim 3, wherein:
the extension element in the TDLS B-TWT request frame comprises information associated with the schedule of the B-TWT, and
the identification field identifies a B-TWT schedule advertised by the AP.

6. The method of claim 3, wherein the TDLS TWT notification frame comprises a TDLS B-TWT request action frame including one or more of a category field, a TDLS action field, a dialog token field, a link identifier field, and a TWT information extension field.

7. The method of claim 3, wherein the TDLS TWT notification frame includes a capability indication field that indicates whether the first STA supports broadcast TWT awareness for a TDLS operation.

8. A first station (STA) device comprising:
a transceiver; and
a processor operably coupled to the transceiver, the processor configured to:
establish a tunneled direct link setup (TDLS) direct link with a second STA, wherein the first STA and the second STA are associated with an access point (AP) device;
obtain membership of a restricted target wake time (R-TWT) schedule or a broadcast TWT (B-TWT) schedule that allows peer-to-peer (P2P) communication between the first STA and the second STA during a corresponding R-TWT service period (SP) or B-TWT SP;
determine an intention to transmit frames to the second STA during the R-TWT SP or the B-TWT SP corresponding to the R-TWT schedule or the B-TWT schedule; and
transmit, via the transceiver, a TDLS TWT notification frame to the second STA prior to a start of the R-TWT SP or the B-TWT SP, wherein the TDLS TWT notification frame includes information associated with a schedule of the R-TWT or the B-TWT.

9. The first STA device of claim 8, wherein:
the information associated with the schedule of the R-TWT or the B-TWT is included in a TWT element in the TDLS TWT notification frame or in a TDLS TWT notification element in the TDLS TWT notification frame, and
the TDLS TWT notification element includes information that identifies a TWT schedule during which the first STA intends to transmit frames to the second STA.

10. The first STA device of claim 8, wherein:
the first STA is a member of the B-TWT schedule and intends to transmit frames to the second STA during the B-TWT schedule, and
the processor is further configured to transmit, via the transceiver, a TDLS B-TWT request frame to the second STA, wherein the B-TWT schedule is identified by an identification field in an extension element in the TDLS B-TWT request frame.

11. The first STA device of claim 10, wherein:
the processor is further configured to receive a TDLS B-TWT response frame indicating success,
the TDLS B-TWT response frame includes an identification field in an extension element, and
a value in the identification field in the extension element of the TDLS B-TWT response frame is the same as a value in the identification field in the extension element of the TDLS B-TWT request frame.

12. The first STA device of claim 10, wherein:
the extension element in the TDLS B-TWT request frame comprises information associated with the schedule of the B-TWT, and
the identification field identifies a B-TWT schedule advertised by the AP.

13. The first STA device of claim 10, wherein the TDLS TWT notification frame comprises a TDLS B-TWT request action frame including one or more of a category field, a TDLS action field, a dialog token field, a link identifier field, and a TWT information extension field.

14. The first STA device of claim 10, wherein the TDLS TWT notification frame includes a capability indication field that indicates whether the first STA supports broadcast TWT awareness for a TDLS operation.

15. An access point (AP) device comprising:
a transceiver; and
a processor operably coupled to the transceiver, the processor configured to:
determine that a first station (STA) associated with the AP device has established a tunneled direct link setup (TDLS) direct link with a second STA associated with the AP device;
determine that the first STA is a member of a restricted target wake time (R-TWT) schedule that allows peer-to-peer (P2P) communication between the first STA and the second STA during a corresponding R-TWT service period (SP);
determine an intention of the first STA to transmit frames to the second STA during the R-TWT SP corresponding to the R-TWT schedule; and
transmit, via the transceiver, a TDLS TWT notification frame to the second STA prior to a start of the R-TWT SP, wherein the TDLS TWT notification frame includes information associated with a schedule of the R-TWT.

16. The AP device of claim 15, wherein the TDLS TWT notification frame comprises a TDLS TWT awareness frame that includes association identifier (AID) information of the first STA.

17. The AP device of claim 15, wherein the TDLS TWT notification frame comprises a TDLS TWT awareness frame, and the information associated with the schedule of the R-TWT is included in a TWT element in the TDLS TWT awareness frame.

18. The AP device of claim 15, wherein the TDLS TWT notification frame comprises a TDLS TWT awareness frame, and the TDLS TWT awareness frame includes a TDLS TWT notification element that includes information that identifies a TWT schedule during which the first STA intends to transmit frames to the second STA.

19. The AP device of claim 18, wherein the TDLS TWT notification element includes a broadcast TWT identification of the R-TWT schedule.

20. The AP device of claim 15, wherein the TDLS TWT notification frame comprises a TDLS TWT awareness frame, and the processor is configured to receive an acknowledgement associated with receipt of the TDLS TWT awareness frame from the second STA.
